(19) United States
(12) Patent Application Publication
(10) Pub. No.: US 2011/0083563 A1
(43) Pub. Date: Apr. 14, 2011

(54) Steamer insert and method

(75) Inventor: Rodney A. Branson, Fond Du Lac, WI (US)

(73) Assignee: Regal Ware, Inc.

(21) Appl. No.: 12/924,349

(22) Filed: Sep. 24, 2010

Related U.S. Application Data
(63) Continuation-in-part of application No. 12/803,107, filed on Jun. 18, 2010.
(60) Provisional application No. 61/277,384, filed on Sep. 24, 2009.

(51) Int. Cl. A47J 27/04

(52) U.S. Cl. 99/410

(57) ABSTRACT

n apparatus and method of steaming food products such as tamales is disclosed. The method may include the steps of: providing a food product to be steamed, providing a vessel capable of retaining and boiling a liquid, placing a liquid in the vessel to a predetermined level; providing a food supporting inset, the inset being adapted to fit inside the cooking vessel; providing the inset with a tubular conduit having an axis, an inlet, and an outlet.

### RELATED APPLICATIONS

This application claims the benefit of U.S. Provisional Patent Application Ser. No. 61/277,384, filed 24 Sep. 2009, and is a continuation-in-part of U.S. patent application Ser. No. 12/803,107, filed on 18 Jun. 2010.

### BACKGROUND OF THE INVENTION

Steaming foods is a popular method of food preparation. Foods that may be prepared by steaming include, for example vegetables or tamales. A typical steamer for use in steaming food may include a main pot, its lid, and a rack to place at the bottom of the pot to hold the food product just above the waterline. Some problems associated with typical steamers, especially those to be used to steam tamales, include poorly fitting lids, or lids made of material which is so thin that a tight fit is not possible. Steamers such as these permit steam to run off, which in turn forces the user of the device to add water constantly, or burn the food. Further, when steaming food, it is important to avoid boiling the food, so it is undesirable for water to touch the food. When tamales are to be steamed, for example, authentic Mexican tamale steamers are often simply galvanized buckets having lids with steaming inserts in the bottom. Also common are bamboo steamers that are readily available at kitchen or house ware stores. Traditional steamers such as these require the user to remove the lid repeatedly when more liquid is required. This slows the cooking time significantly. The present invention contemplates a food steamer inset, or steaming vessel with such an inset, which permits continuous steaming on high heat, without disturbing the cooking process.

### SUMMARY OF THE INVENTION

The present invention is directed toward an inset for use in a food steamer, a cooking implement including such an inset, and method of using same.

A device according to the present invention may be adapted to fit inside a cooking vessel and includes a tubular conduit having an axis, and a perforate rack capable of supporting the food thereon during steaming. The rack preferably extends radially from the axis of the conduit. The conduit further includes an inlet and an outlet. The tubular conduit provides a fluid passageway for the water or other fluid to be used in steaming the food product, with the inlet being adapted to receive fluid therethrough, and providing a conduit for the fluid to the outlet. The outlet adapted to be in fluid communication with the vessel cavity.

The invention provides a steamer inset which permits the steaming liquid to be replenished without movement of the food items within. The invention further provides a steamer with improved elements and arrangements thereof which is inexpensive, dependable, and fully effective in accomplishing its intended purposes.

### BRIEF DESCRIPTION OF THE DRAWINGS

FIG. 1 is a perspective view showing a cooking vessel of the type for use with the present invention.

FIG. 2 is a partially exploded view of the vessel shown in FIG. 1, but with the cover removed for ease in viewing the insert.

FIG. 3 is across sectional view of the vessel illustrated in FIG. 1 and taken along lines 3-3 thereof.

FIG. 4 is a cross sectional view similar to that of FIG. 3, but showing an alternative embodiment thereof.

FIG. 5 is a cross sectional view similar to those of FIGS. 3 and 4, and showing another alternative embodiment.

FIG. 6 is a cross sectional view similar to those of FIGS. 3-5, and showing another alternative embodiment.

FIG. 7 is a cross sectional view similar to those of FIGS. 3-6, and showing another alternative embodiment.

FIG. 8 is a cross sectional view similar to those of FIGS. 3-8, and showing another alternative embodiment.

FIG. 9 is a cross sectional view of a tamale cooker provided with a sight glass for determining water level in the interior of the vessel while cooking.

FIG. 10 is a cross sectional view of a tamale cooker provided with a alternate embodiment of a sight glass for determining water level in the interior of the vessel while cooking.

FIG. 11 is a cross sectional view of a tamale cooker provided with a bobber for determining water level in the interior of the vessel while cooking.

FIG. 12 is a cross sectional view of a tamale cooker provided with an alternate embodiment of a bobber for determining water level in the interior of the vessel while cooking.

FIGS. 13-16 are cross sectional views of alternate embodiments of a tubular conduit with vents throughout the conduit for transporting steam from the bottom of the vessel to the layers of the vessel.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

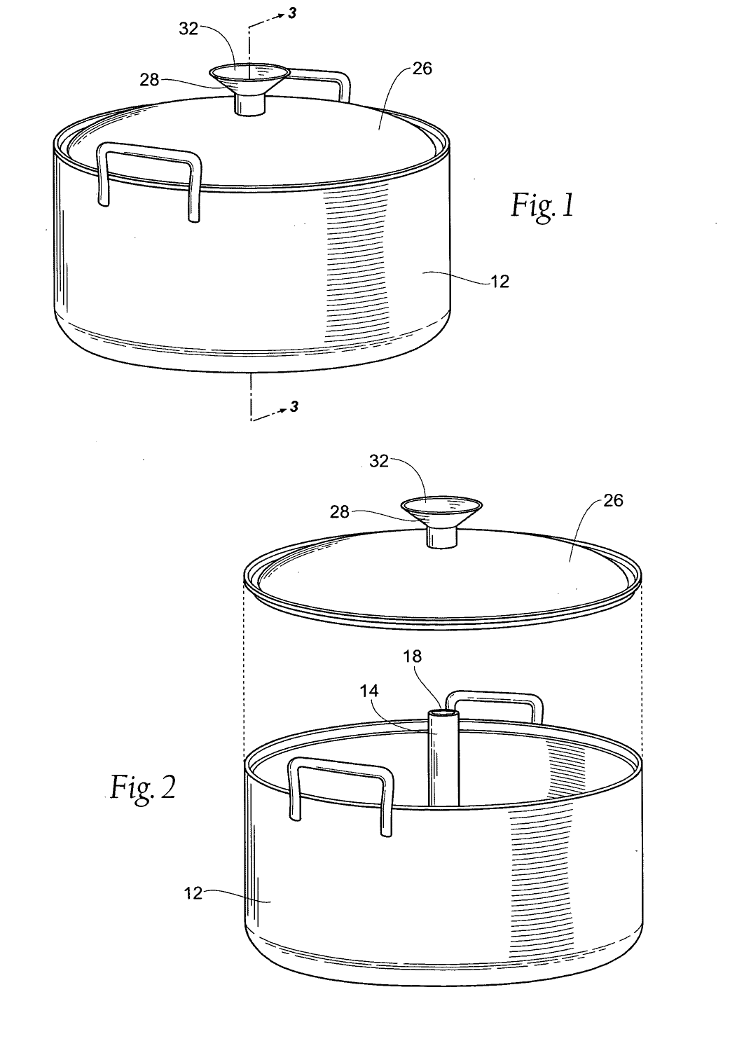

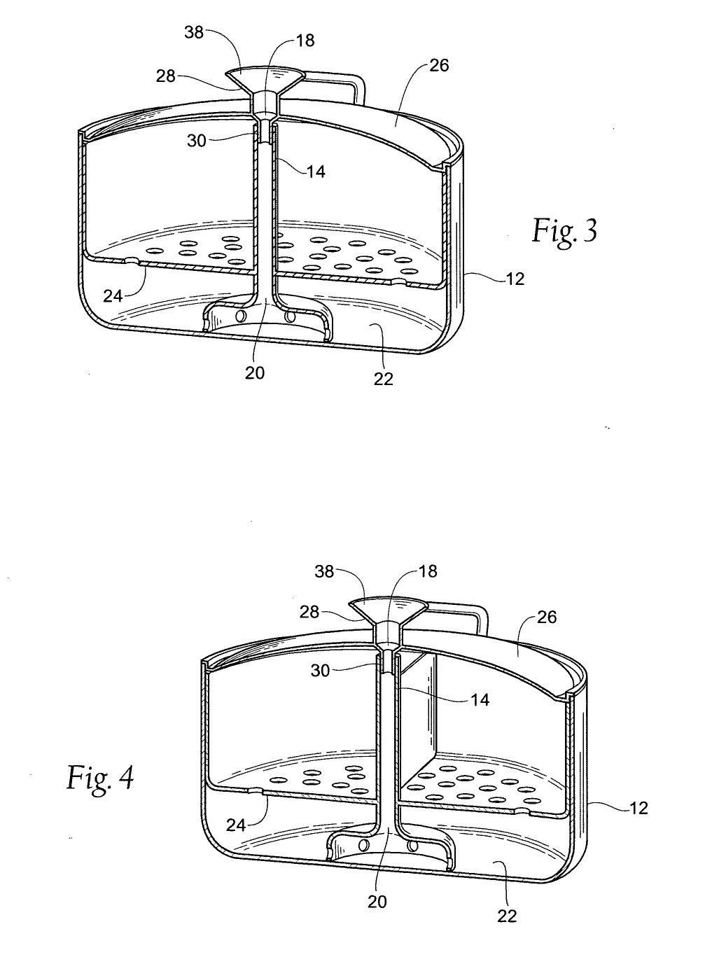

With particular reference to FIGS. 1-3, a steamer inset 10 according to the present invention may be seen. As shown, the inset 10 is adapted to fit inside a cooking vessel 12 and includes a tubular conduit 14 having an axis 16, an inlet 18, and an outlet 20. The tubular conduit 14 provides a fluid passageway for the water or other fluid (not shown) to be used in the steaming process, with the inlet 18 being adapted to receive fluid therethrough, and providing a conduit for the fluid to the outlet 20 which is in fluid communication with the vessel cavity 22. As illustrated particularly in the view of FIG. 3, the inset 10 preferably includes at least one perforated rack 24 capable of supporting food (not shown) to be steamed thereon. The rack 24 extends radially from the axis 16 of the conduit 14. As may also be observed, the lid 26 of the vessel 12 may include a knob 28 having a longitudinally extending, tubular neck portion 30, in communication with an opening 32. As viewed particularly in FIGS. 3 and 4, the neck portion 30 is preferably adapted to fit inside the inlet 18 to thereby provide fluid access to the conduit 14 while the lid 26 is in place.

With reference now to FIG. 4, an inset according to the present invention may be seen to include a longitudinally extending partition 34. The partition 34 supports and divides the food to be steamed such that multiple foods may be simultaneously steamed, and elongate foods may be supported and steamed in an upstanding configuration, if desired.

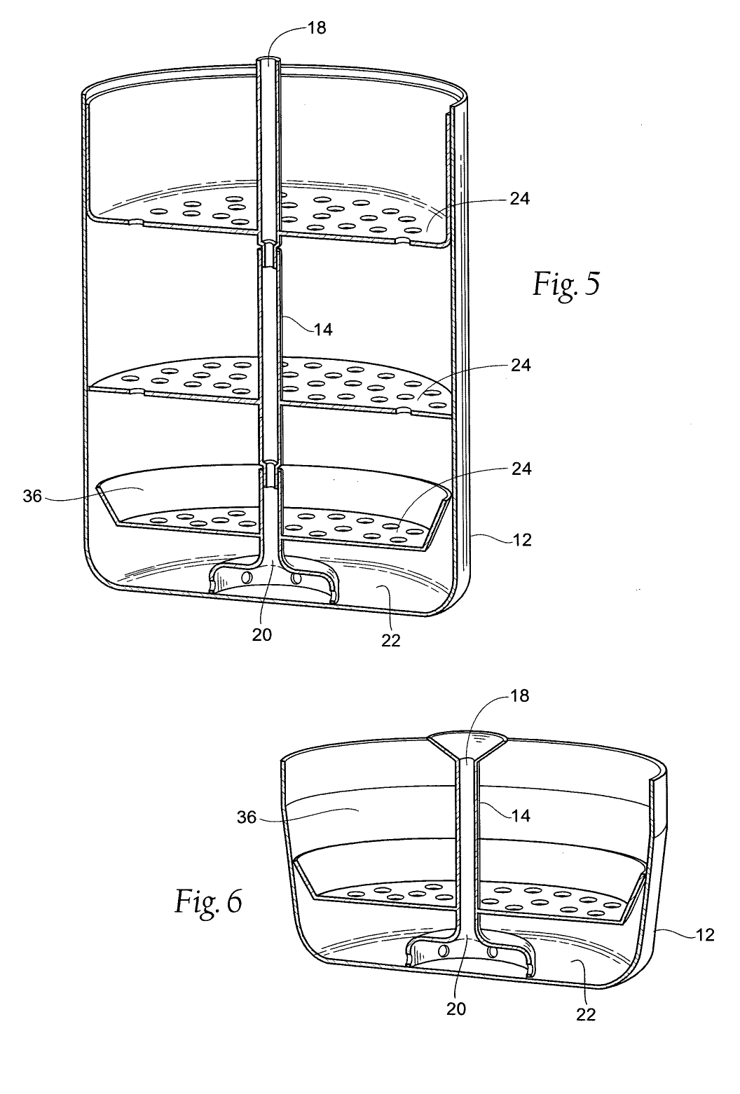

As seen in FIG. 5, a device according to the present invention may include multiple, radially extending perforate racks 24. As illustrated in FIGS. 5 and 6, the racks 24 may be provided with an annular flanged portion 36.

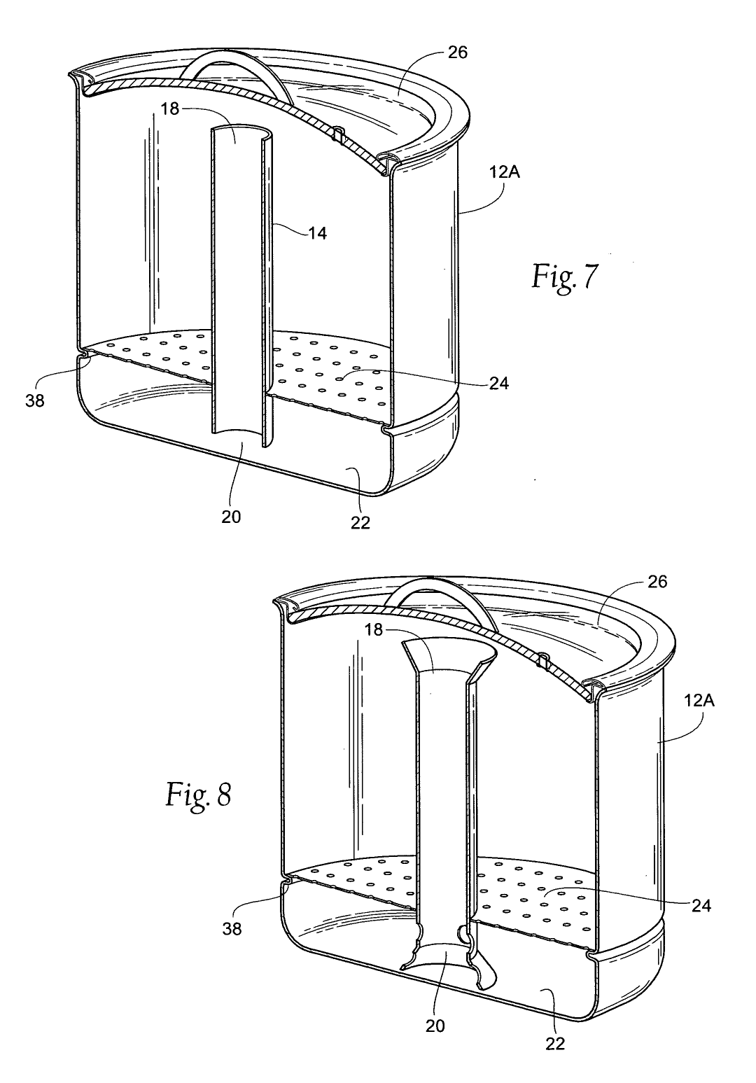

FIGS. 7 and 8 illustrate the inset 10 of the present invention as used with an alternative cooking vessel 12A, in which the vessel includes an inwardly projecting annular ring 38. As shown, the ring 38 is adapted to support the rack 24 thereon.

It is contemplated that the inventive inset 10 may be constructed from aluminum or other suitable metallic substance or combination of substances. Also, individual components of the device may be joined by weld or any other suitable means known in the art.

The present invention is also contemplated as a method of steaming food products, such as tamales. The method may include the steps of: providing a food product to be steamed, providing a vessel capable of retaining and boiling a liquid, such as water therein; placing a liquid in the vessel to a predetermined level; providing a food supporting inset, the inset being adapted to fit inside the cooking vessel; providing the inset with a tubular conduit having an axis, an inlet, and an outlet, the inlet being adapted to receive fluid therethrough, the conduit being adapted to provide a fluid passageway for the liquid from the inlet to the outlet, the outlet being in fluid communication with the vessel cavity; providing the inset with at least one perforate rack capable of supporting food thereon, the rack extending radially from the axis of the conduit; placing a food product on rack; heating the liquid to a predetermined temperature; allowing the food product to steam for predetermined period; adding additional liquid through inlet as required during steaming process.

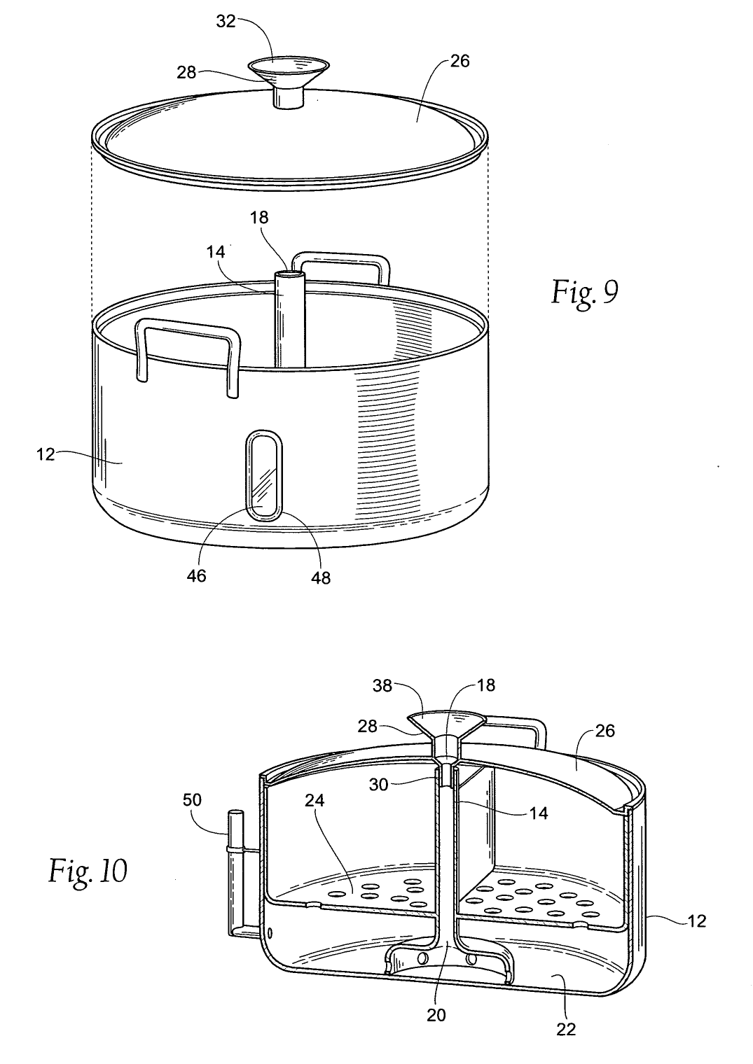

Referring now to FIG. 9, a cross sectional view of a tamale cooker provided with a sight glass 48 for determining water level in the interior of the vessel while cooking is shown. The sight glass 48 is preferably coupled with the vessel 12 by an annular seal 48. Preferably, the sight glass 48 is clear, so the operator of the tamale cooker can visually determine whether the water level in the bottom of the reservoir is at an appropriate level, i.e., enough water to steam, but not too much water to rise to the level of the perforated rack 24 while cooking.

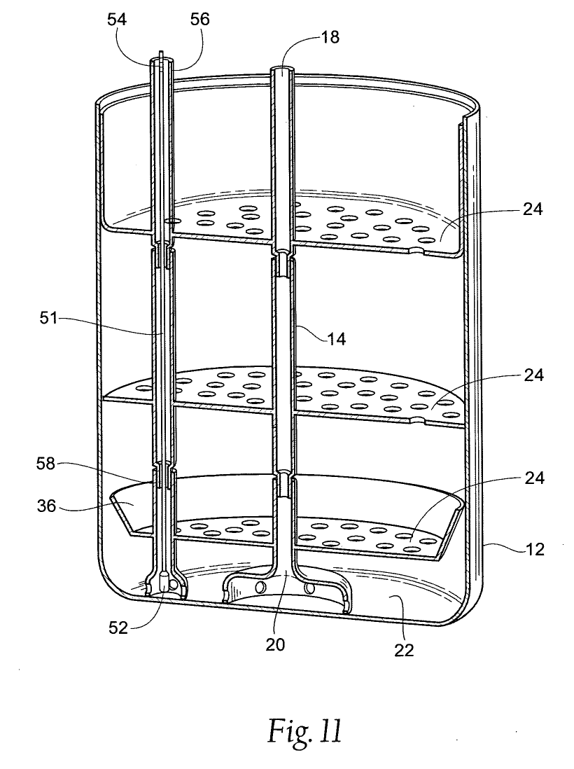

Referring now to FIG. 10, a cross sectional view of a tamale cooker provided with a alternate embodiment of a sight glass 50 for determining water level in the interior of the vessel while cooking is shown. External sight glass 50 is also provided to visually determine whether the water level in the bottom of the reservoir is at an appropriate level, i.e., enough water to steam, but not too much water to rise to the level of the perforated rack 24 while cooking.

Referring now to FIG. 11, a cross sectional view of a tamale cooker provided with a bobber 51 for determining water level in the interior of the vessel while cooking is shown. The bobber is provided in a shaft 56, such that a float bulb 52 can rise or fall with the water level, and a user can determine visually determine whether the water level in the bottom of the reservoir is at an appropriate level, i.e., enough water to steam, but not too much water to rise to the level of the perforated rack 24 while cooking, by inspecting the preferably color-coded level indicator 54 on the exterior of the shaft 56. In a preferred embodiment, the bulb is retained in the shaft 56 by a necked portion 58 provided in the shaft 56.

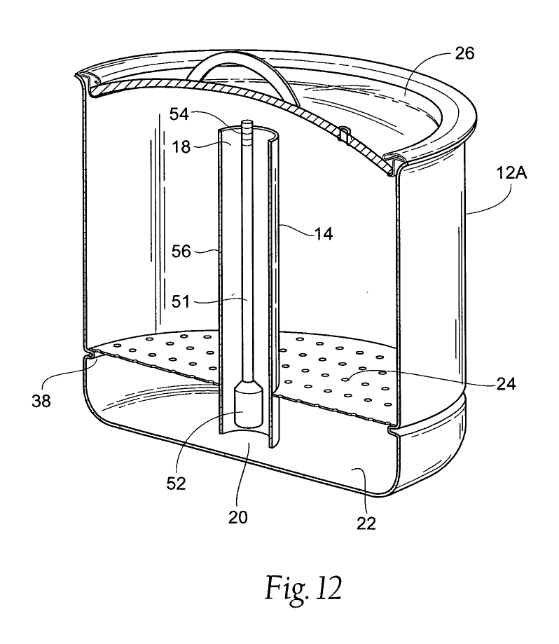

Referring now to FIG. 12, a cross sectional view of a tamale cooker provided with an alternate embodiment of a bobber 51 for determining water level in the interior of the vessel while cooking is shown.

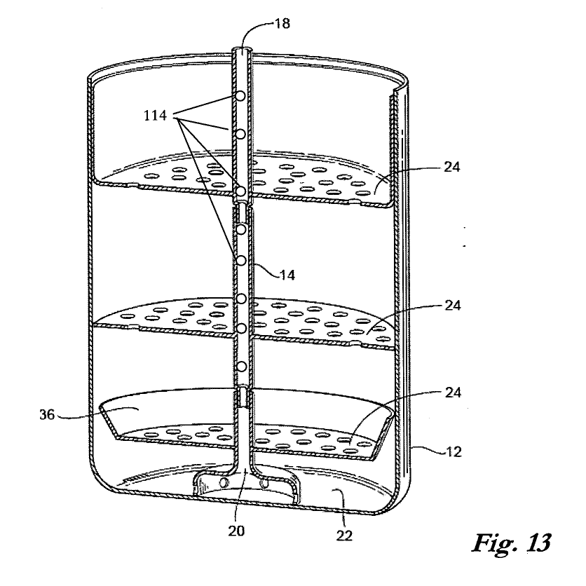

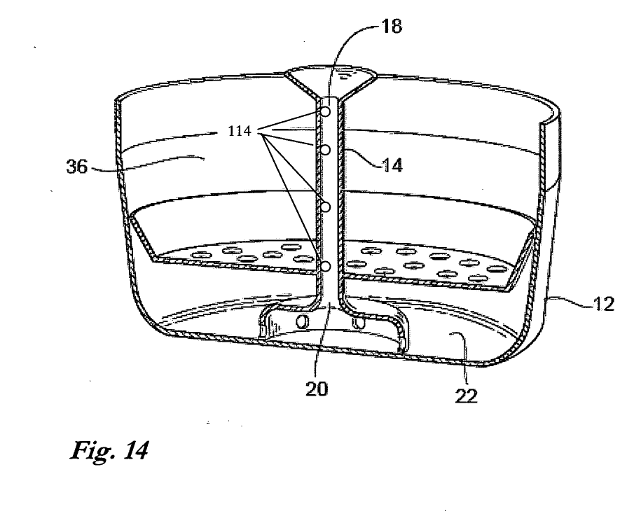

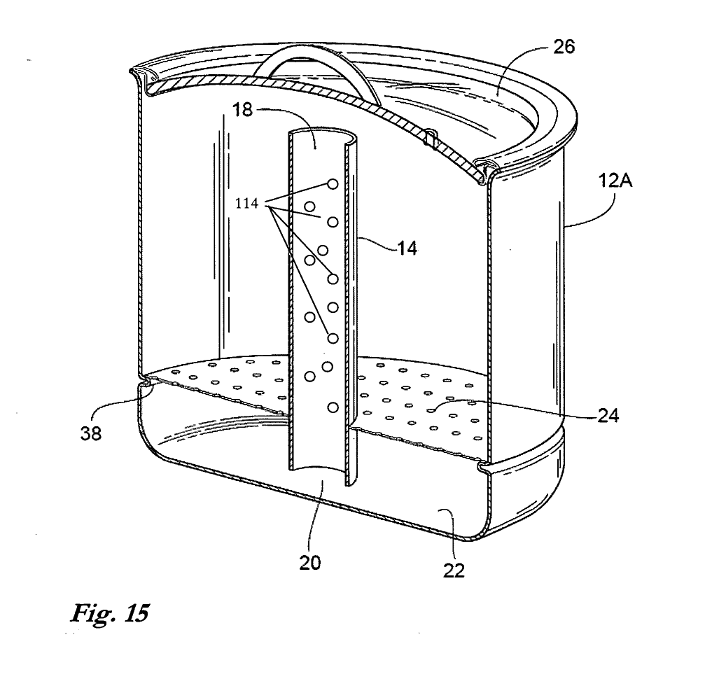

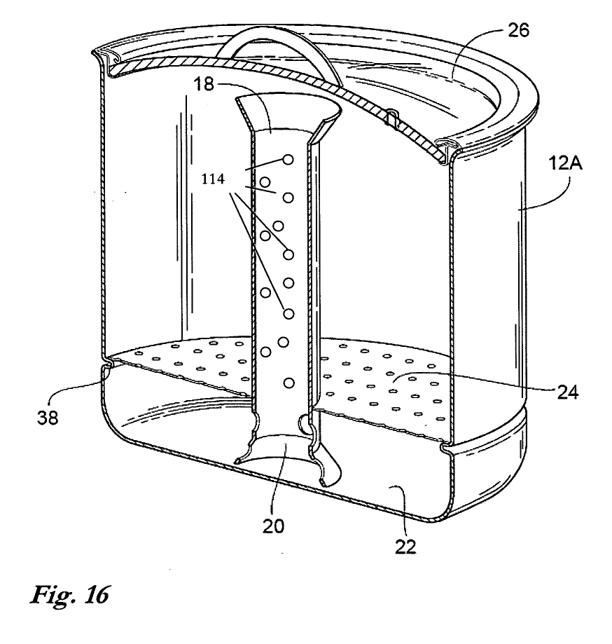

Referring now to FIGS. 13-16, cross sectional views of alternate embodiments of the tubular conduits are shown. As can be seen, vents 114 can be provided at different horizontal levels throughout the conduit 14 for transporting steam, in order to distribute the steam throughout the vessel, which can result is less the time to steam the tamales.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. Cookware comprising:
a vessel for containing a food product and a fluid evaporating into steam;
said vessel comprising an exterior and interior, said vessel comprising a substantially flat bottom surface; a side surface, and a removable lid, and an exterior;
a false bottom surface for carrying said food product, said false bottom surface positioned between said bottom surface and said removable lid, said false bottom surface comprising a surface for carrying food product and void spaces for allowing rising migration of the steam;
a passageway from the exterior to the interior of the vessel for introducing said fluid to an area between said bottom surface and said false bottom surface, said passageway comprising a column for transporting said fluid through and past said false bottom surface to the area between said bottom surface and said false bottom surface, void spaces provided at a plurality of locations between said false bottom surface and said removable lid, said false bottom keeping said food product isolated from said fluid and allowing said food product to come into contact with said steam migrating from said fluid.
